(19) United States
(12) Patent Application Publication
(10) Pub. No.: US 2022/0308494 A1
(43) Pub. Date: Sep. 29, 2022

(54) IMAGE FORMING APPARATUS

(71) Applicant: KYOCERA Document Solutions Inc., Osaka-shi (JP)

(72) Inventor: Kenichi TANAKA, Osaka-shi (JP)

(21) Appl. No.: 17/700,669

(22) Filed: Mar. 22, 2022

(30) Foreign Application Priority Data
Mar. 29, 2021 (JP) 2021-054842

(51) Int. Cl. G03G 15/01; G06F 21/31

(52) U.S. Cl. CPC G03G 15/0105; G06F 21/31

(57) ABSTRACT

A user authentication unit executes user authentication in a first stage and user authentication in a second stage of an authentication method different from the user authentication in the first stage. The job management unit: (a) after the user authentication in the first stage succeeds, the service request is accepted, whether or not the service designated by the service request is a service requiring the two-stage authentication is determined, (b) when the service is a service requiring the two-stage authentication, the service is executed after the user authentication in the second stage succeeds, and when the service is not a service requiring the two-stage authentication, the service is executed without performing the user authentication in the second stage.

### INCORPORATION BY REFERENCE

This application is based upon, and claims the benefit of priority from, corresponding Japanese Patent Application No. 2021-054842 filed in the Japan Patent Office on Mar. 29, 2021, the entire contents of which are incorporated herein by reference.

### BACKGROUND

The present disclosure relates to an image forming apparatus.

A certain image reading apparatus performs a two-stage authentication using an authentication apparatus on the cloud, and when the two-stage authentication is successful, executes a process corresponding to the received request.

### SUMMARY

The image forming apparatus according to the present disclosure includes; an internal device: a job management unit which receives a service request and executes a service designated by the service request using the internal device; and a user authentication unit which executes user authentication in a first stage and user authentication in a second stage of an authentication method different from the user authentication in the first stage. Then, the job management unit: (a) after the user authentication in the first stage succeeds, the service request is accepted, whether or not the service designated by the service request is a service requiring the two-stage authentication is determined, (b) when the service is a service requiring the two-stage authentication, the service is executed after the user authentication in the second stage succeeds, and when the service is not a service requiring the two-stage authentication, the service is executed without performing the user authentication in the second stage.

### BRIEF DESCRIPTION OF THE DRAWINGS

FIG. 1 is a block diagram illustrating a configuration of an image forming system including an image forming apparatus according to an embodiment of the present disclosure.

FIG. 2 is a block diagram illustrating a configuration of an image forming apparatus according to an embodiment of the present disclosure.

FIG. 3 is a flowchart for explaining the operation of the image forming apparatus 1 illustrated in FIGS. 1 and 2.

### DETAILED DESCRIPTION

Embodiments of the present disclosure will be described below with reference to the drawings.

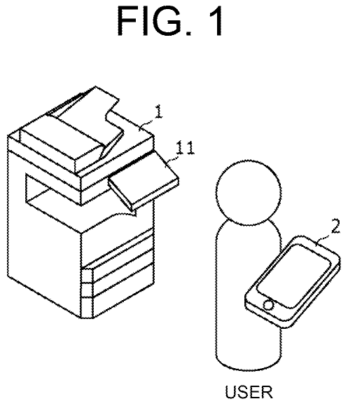

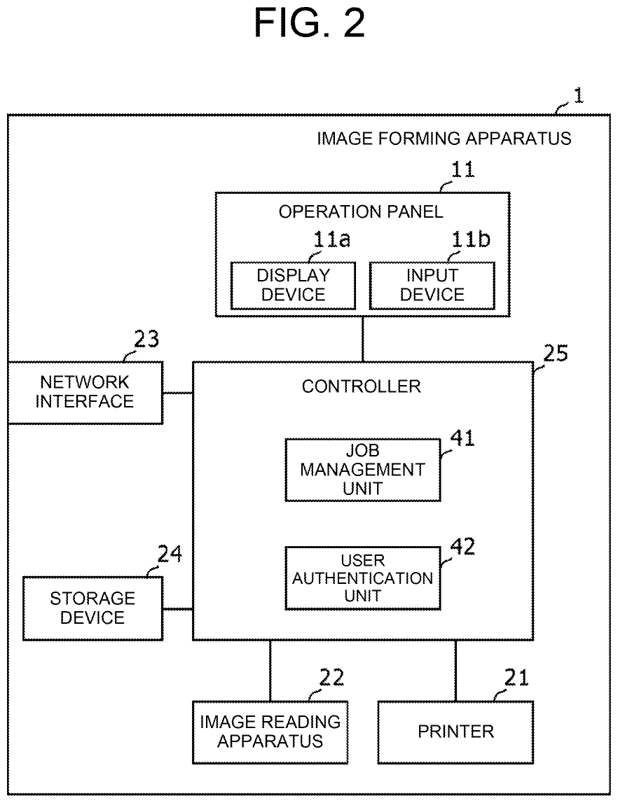

FIG. 1 is a block diagram illustrating a configuration of an image forming system including an image forming apparatus according to an embodiment of the present disclosure. FIG. 2 is a block diagram illustrating a configuration of an image forming apparatus according to an embodiment of the present disclosure.

In the system illustrated in FIG. 1, the image forming apparatus 1 (multifunction machines, copiers, etc.) is installed in a place usable by a user (offices, convenience stores, etc.), and the user carries a portable terminal device 2 such as a smartphone. For example, the portable terminal device 2 is a portable device such as a smartphone, and includes a network interface, a communication device such as a communication device of a cellular phone network, and a display device.

The image forming apparatus 1 illustrated in FIG. 2 is a multifunction machines that can be used by a user, and includes an operation panel 11, a printer 21, an image reading apparatus 22, a network interface 23, a storage device 24, and a controller 25.

The operation panel 11 is disposed on the surface of the housing of the image forming apparatus 1 and includes a display device 11a for displaying various messages to a user and an input device 11b for receiving user operations. For example, a liquid crystal display is used as the display device 11a. A key switch, a touch panel, an IC card reader, or the like is used as the input device 11b.

The printer 21 is an internal device for printing an image to be provided by various printing services on a printing sheet by, for example, an electrophotographic method.

The image reading apparatus 22 is an internal device that reads an original image from a user's original in various scanning services, copying services, facsimile transmission services, and the like, and generates image data thereof.

The network interface 23 is an internal device connected to a network such as a wireless LAN or a wired LAN and performing data communication with other devices (portable terminal device 2, a server (not shown), etc.) connected to the network.

The storage device 24 is a nonvolatile storage device such as a flash memory or a hard disk, and stores programs and data necessary for providing various services.

The controller 25 is a computer having a Central Processing Unit (CPU), a Random Access Memory (RAM), a Read Only Memory (ROM), or the like, an Application Specific Integrated Circuit (ASIC), or the like, and operates by loading a program into the RAM and executing it in the CPU, and operates as various processing units.

Here, the controller 25 operates as the job management unit 41 and the user authentication unit 42.

The job management unit 41 receives the service request, and executes, as a job, the service designated by the service request based on the user operation to the operation panel 11 by using the aforementioned internal device (printer 21, image reading apparatus 22, network interface 23, etc.).

A user authentication unit 42 performs user authentication in the first stage and user authentication in the second stage of an authentication method different from the user authentication in the first stage.

In this embodiment, the user authentication in the first stage is password authentication, and the user authentication in the second stage is SMS (Short Message Service) authentication or mail authentication.

In the SMS authentication or the mail authentication, an authentication code is transmitted to a user who has succeeded in the user authentication in the first stage, and when the authentication code is input to the image forming apparatus, the authentication succeeds, and when the authentication code is not input to the image forming apparatus, the authentication fails.

The job management unit 41 (a) receives a service request after the user authentication in the first stage succeeds, determines whether or not the service designated by the service request is a service for which the two-stage authentication is requested, and (b) executes the service after succeeding in the user authentication in the second stage when the service is a service for which two-stage authentication is required, and executes the service without performing the user authentication in the second stage when the service is not a service for which two-stage authentication is required.

Here, for example, the service request is a request for a service selected from a plurality of predetermined services presented to the user as a menu screen, and the plurality of services include a service for which the two-stage authentication is required and a service for which two-stage authentication is not required. Here, the service requiring the two-stage authentication is a service using the personal information of the user, and the service not requiring the two-stage authentication is a service not using the personal information of the user.

For example, a service requiring the two-stage authentication is a printing service of an official certification document such as a residence certificate or a seal impression certificate, and a service not requiring the two-stage authentication is a copying service of a user's original.

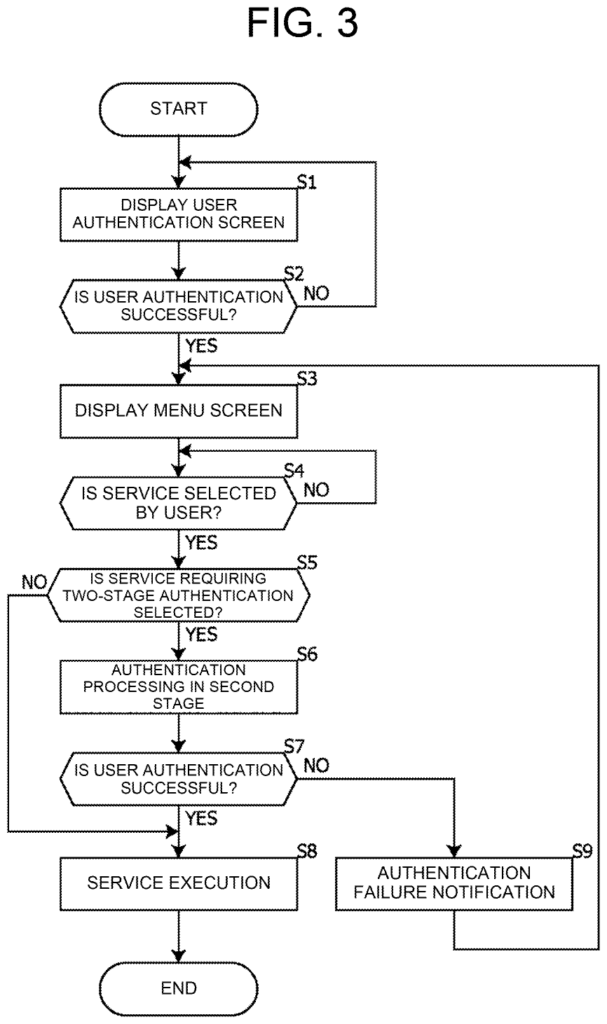

Next, the operation of the image forming apparatus 1 will be described. FIG. 3 is a flowchart for explaining the operation of the image forming apparatus 1 illustrated in FIGS. 1 and 2.

When the image forming apparatus 1 starts, the user authentication unit 42 displays a user authentication screen on the display device 11a (step S1). The user authentication screen includes user ID and password input fields for password authentication.

When the character string of the user ID and the character string of the password are input to the input field of the user ID and the password in the user operation to the input device 11b, the user authentication unit 42 executes password authentication (user authentication in the first stage) based on the input character string and determines whether or not the user authentication (password authentication) has succeeded (step S2).

The user authentication unit 42 performs password authentication by using user data (user ID and password pair of the registered user) stored in advance in the storage device 24, or accesses an external authentication server by using the network interface 23, and transmits the input character string to the authentication server to cause the authentication server to perform password authentication.

When password authentication fails, a user authentication unit 42 continues to display a user authentication screen.

When the password authentication is successful, the job management unit 41 displays a menu screen including a list of a plurality of services, on the display device 11a (step S3).

When a user operation for selecting a service in a list of a plurality of services is detected by an input device 11b (step S4), a user authentication unit 42 determines whether the selected service is a service requiring two-stage authentication (step S5).

A flag indicating whether or not two-stage authentication is required is set for the plurality of services, and setting data including the flag is stored in the storage device 24. The user authentication unit 42 refers to the setting data and determines whether or not the selected service is a service requiring two-stage authentication based on the value of the flag for the selected service.

When the selected service requires two-stage authentication, the user authentication unit 42 executes the authentication processing in the second stage (step S6).

In the authentication processing in the second stage, the user authentication unit 42 specifies the transmission destination of the authentication code corresponding to the user, generates the authentication code, and transmits a transmission request including the authentication code and the transmission destination to the SMS authentication server or the mail authentication server by using the network interface 23. Upon receiving the transmission request, the SMS authentication server or the mail authentication server transmits the authentication code designated in the transmission request to the transmission destination designated in the transmission request by using the SMS or the e-mail service. The user operates the portable terminal device 2 to display and confirm the authentication code on the portable terminal device 2 and inputs it to the image forming apparatus 1.

The transmission destination of the authentication code corresponding to the user is registered in association with the user ID or the like in the user data and the authentication server described above, and the user authentication unit 42 specifies the transmission destination by referring to the user data and the authentication server described above.

In the authentication process in the second stage, the user authentication unit 42 displays the authentication code input screen on the display device 11a after the transmission of the transmission request, specifies the character string input as the authentication code, and determines whether the character string matches the authentication code.

Then, the job management unit 41 determines whether or not the user authentication in the second stage is successful (step S7), and when the user authentication in the second step is successful, the job management unit 41 executes the selected service (step S8). On the other hand, if the user authentication in the second stage fails, the job management unit 41 displays a message indicating the authentication failure on the display device 11a (step S9), and the process returns to step S3.

If the selected service is not a service requiring two-stage authentication in step S5, the job management unit 41 immediately executes the selected service right away, without executing the user authentication in the second stage (step S8).

As described above, according to the above embodiment, the user authentication unit 42 performs user authentication in the first stage and user authentication in the second stage of an authentication method different from the user authentication in the first stage. A job management unit 41 (a) receives a service request after succeeding in the user authentication in the first stage, determines whether or not the service designated by the service request is a service for which two-stage authentication is required, (b) executes the service after succeeding in the user authentication in the second stage when the service is a service for which two-stage authentication is required, and executes the service without performing the user authentication in the second stage when the service is not a service for which two-stage authentication is required.

Thus, since the service is executed without performing the user authentication in the second stage for the service having a relatively low security level, the convenience of the user is improved while securing the security corresponding to the service to be provided.

Various modifications and modifications to the above-described embodiments will be apparent to those skilled in the art. Such changes and modifications may be made without departing from the spirit and scope of the subject matter and without diminishing the intended advantage. That is, such changes and modifications are intended to be included in the claims.

### INDUSTRIAL APPLICABILITY

The present disclosure is applicable, for example, to an image forming apparatus.

What is claimed is:

1. An image forming apparatus, comprising:
an internal device;
a job management unit that accepts a service request and uses the internal device to execute a service designated by the service request; and
a user authentication unit that performs user authentication in a first stage and user authentication in a second stage of an authentication method different from the user authentication in the first stage,
wherein the job management unit (a) receives the service request after the user authentication in the first stage succeeds, determines whether or not the service designated by the service request is a service for which two-stage authentication is required, (b) executes the service after the user authentication in the second stage succeeds when the service is a service for which two-stage authentication is required, and executes the service without performing the user authentication in the second stage when the service is not a service for which two-stage authentication is required.

2. The image forming apparatus according to claim 1,
wherein the service request is a request for a service selected from a plurality of predetermined services presented to a user,
wherein the plurality of services include a service for which the two-stage authentication is required and a service for which the two-stage authentication is not required, and
wherein the service for which the two-stage authentication is required is a service using personal information of the user, and the service for which the two-stage authentication is not required is a service not using the personal information of the user.

3. The image forming apparatus according to claim 1,
wherein the user authentication in the first stage is password authentication, and
wherein the user authentication in the second stage is SMS authentication or mail authentication.
